(19) United States
(12) Patent Application Publication
(10) Pub. No.: US 2012/0017412 A1
(43) Pub. Date: Jan. 26, 2012

(54) PACKAGE AND DISPENSING SYSTEM

(76) Inventors: PAUL RICHARD PIERSON, Camden, DE (US); Curt E. Metzbower, Washington Crossing, PA (US); Robert J. Pieroni, Lewes, DE (US)

(21) Appl. No.: 12/898,909

(22) Filed: Oct. 6, 2010

Related U.S. Application Data
(63) Continuation of application No. 11/980,835, filed on Oct. 31, 2007, now abandoned.
Application No. 11/980,835 is a continuation-in-part of application No. 11/451,108, filed on Jun. 12, 2006, now Pat. No. 8,016,161.
Application No. 11/451,108 is a continuation of application No. 11/293,447, filed on Dec. 2, 2005, now abandoned.
(60) Provisional application No. 60/633,085, filed on Dec. 3, 2004.
(60) Provisional application No. 60/657,749, filed on Mar. 2, 2005.

(51) Int. Cl. B23P 11/00

(52) U.S. Cl. 29/428

(57) ABSTRACT

A package (10) for the storage and dispensing of a plurality of material 10as includes a first and a second longitudinally juxtaposed barrels (11, 12). Each barrel (11, 12) having a first and a second end (20, 21). Each first and second barrels (11, 12) having a quantity of at least one of the material 10as initially contained therein, and each barrel having an open end (20) and a dispensing end (21). A piston (40) is disposed in each barrel (11, 12) such that the material 10a in each barrel (11, 12) is initially positioned between the dispensing end (21) of the barrels (11, 12) and the respective ones of the pistons (40). A snap cap (23) is contiguously formed to initially close each of the dispensing ends (21) of the barrels (11, 12), such that the snap cap (23) may be broken from the barrels (11, 12) to thereby forming a secondary open end (31) at the dispensing end (21) of the barrels (11, 12), thereby facilitating the material 10a contained in each barrel (11, 12) to flow through and be dispensed.

### RELATED APPLICATIONS

This application is a Continuation of pending U.S. application Ser. No. 11/980,835 filed Oct. 31, 2007 which is a Continuation-in-Part of pending U.S. application Ser. No. 11/451,108 filed Jun. 12, 2006, which claimed priority from abandoned U.S. application Ser. No. 11/293,447 filed Dec. 2, 2005 which claimed priority from both of Provisional Application Ser. No. 60/633,085 filed on Dec. 3, 2004 and U.S. Provisional Application Ser. No. 60/657,749 filed on Mar. 2, 2005, both provisional applications now expired.

### TECHNICAL FIELD

The invention is directed to a package and dispensing system for flowable, liquid, gel or paste materials, such as dental materials or the like, and has particular application to multi-component materials that are stored separately and mixed before use. The invention has application outside the dental industry (such as for example, with commercial epoxies, industrial adhesives and medical cements) but will be exemplified herein with respect to dental products for illustrative purposes only. More particularly, the invention relates to a multiple-barrel storage and dispensing cartridge having a snap-open cap. The invention also relates to a unit-dose, cartridge delivery system. The cartridges may include a plurality of unit-dose sizes and may be used in conjunction with a universal mixtip and handpiece system. The components may be disposable.

### BACKGROUND OF THE INVENTION

Certain material 10as require specialized packaging for storage and dispensing of the material 10a. For example, with respect to fluid or fluid-like (that is, having an ability to flow either due to gravity or to an applied force) dental material 10as, the material 10as may be light sensitive or the like, requiring packaging that prevents premature exposure of the material 10a to light. Further, dental material 10as such as adhesives, often contain multiple components that need to be separated during storage but that must be mixed immediately prior to use. Further still, it is often necessary to use only a small amount of a material 10a for a given dental procedure. Hence, it is desirable to store and dispense such material 10as in single use or “unit-dose” sizes.

Heretofore, storage and packaging of dental material 10as was often accomplished with multi-use large volume cartridges or double barrel syringes. While such packages often provided for ease of storage, they do not lend themselves well to unit-dose dispensing operations.

Historically, paste/paste products have been packaged in double-barrel syringes with motionless mixing tips. MixPac, TAH Industries and Plas-Pak are several companies that manufacture and market double-barrel syringes and mixtips. Double-barrel syringes are available in standard 2.5 and 5 mL formats. These syringes are suitable for unit-dose applications where the unit of use is approximately 2.5 and 5 mL, but when the unit of use is less than about 2.5 mL they are only suitable for multi-use applications. Therefore, there is a need for a unit-dose, auto-mixing system for paste/paste products where the unit of use is equal to or less than about 2.5 mL.

For example, when cementing a crown onto a tooth, approximately 0.3 mL of cement is needed. It would be wasteful to package a unit-dose amount in a double barrel syringe that was designed for 2.5 mL. As a result, the only viable auto-mix packaging solution for paste/paste cements is a multi-use double barrel syringe.

The present invention seeks to create a true unit-dose packaging and delivery system for the range of paste/paste products that are used in volumes of 2.5 mL or less. In order to achieve the small volumes needed for some dental products a small cartridge was conceived (sometimes referred to as the base unit cartridge, see also FIG. 1). A cartridge that delivers a net 0.3 mL is practical with regards to this design. Adding incremental extensions onto the length of the base cartridge can make cartridges of larger net volumes.

Another example is when a dental practitioner takes an impression by the known dual-phase technique. Users commonly back-fill an intra-oral syringe with low viscosity mixed impression material 10a using a standard 50 mL cartridge and mixtip. GC America manufactures an intermediate intra-oral syringe for the dual-phase technique. The intra-oral syringe improves the technique of applying low viscosity impression material 10a to the prepared tooth. Once the mixed product is in the syringe, it must be used immediately or else it would set up due to the reaction of the two mixed components. The syringe is usually loaded with more than enough material 10a to perform the procedure and must be cleaned and sterilized after use. This procedure provides good clinical technique, but it is cumbersome and wastes much product.

The present unit-dose cartridge delivery system offers the practitioner the same syringe technique while improving ease of use. The system can be assembled and staged prior to use thereby reducing the complexity of the technique and eliminating the critical timing needed to use a back-filled syringe. The technique of using a back-filled syringe wastes about 3 mL of product in order to deliver the 1 mL needed for the procedure (approximately 2 mL in the mixtip and 1 mL in the intra-oral syringe). The present invention reduces waste to only about 0.3 mL of product because the mixtip is much smaller than that of the standard 50 mL cartridge system and an intermediate delivery syringe is not needed.

It should therefore be understood that the present cartridge delivery system reduces wasted product and packaging, improves ease of use and provides true unit-dose, auto-mixing packaging options for products that are used in amounts of 2.5 mL and less.

A need exists therefore, for a package for storing a material 10a and for dispensing the material 10a, especially a dental material 10a such as a multi-component adhesive. The package should protect the material 10a to premature exposure to the environment; it should keep multiple components separate during storage; it should facilitate the dispensing and mixing of premeasured quantities of the material 10a; and, it should be useful for unit-dose quantities of the material 10a to be packaged. A need also exists for an improved delivery and dispensing system for use with such a package.

### DISCLOSURE OF THE INVENTION

It is therefore, an object of the present invention to provide a package for fluid or fluid-like (herein collectively referred to as “fluid”) material 10as.

It is another object of the invention to provide a package as above, with the ability to store a plurality of components.

It is another object of the invention that the package, as above, prevents exposure of the contained material 10a or material 10as to the environment until desired.

It is a further object of the invention to provide a package as above, useful in unit-dose quantities of the packaged material 10as.

It is yet another object of the invention to provide a package that is easily and efficiently useful to an operator.

These and other objects of the invention, which will become apparent from the invention as described herein, are accomplished by the invention as hereinafter described and claimed.

In general, a method for making a package and dispensing system for a material 10a having multiple precursor components, comprises the steps of: providing a cartridge having a plurality of cavities each having a predetermined axis, each said axis of each said plurality of cavities being positioned parallel to one another, wherein said cavities are comprised of an inner and outer wall and each said plurality of cavities being in a spaced and opposed relation to one another, wherein said axis of each said plurality of cavities is separated by a fixed dimension and said outer wall is of a fixed periphery, wherein said inner wall of said cavities are of variable cross section for the purpose of varying the volume of said cavities, said cavities having a proximal opening and a distal opening through which the material 10as may be passed through, wherein said distal openings are on a fixed axial center to axial center dimension and located on a plane between said cavity axis and located within the inner wall boundary of each of the said cavities, wherein said distal openings have an inner and outer wall, wherein said outer wall of said distal opening is of a fixed periphery wherein said inner wall of said distal opening is of a variable cross section for the purpose of varying the flow of material 10a through said distal openings, and, providing a mixtip that affixes to said fixed periphery of said cartridge cavity outer wall and fixed periphery of said distal opening outer wall, providing a dispenser that is comprised of a holding mechanism for said cartridge and mixtip; and, providing a piston mechanism, wherein the piston axis are coincident to the axis of said cartridge cavities and are for exerting axial force to discharge said material 10as.

A method as above may also employ a cavity of said cartridge that lengthened along its axis to increase the volume of said cavity. The distal openings may have lobes that extend inwardly along a plane between the axis of said openings, such that said lobes increase the cross sectional area of said distal openings. The cartridge may be provided with a break-off or -open top for opening said distal openings. The mixtip may be provided with a snap-fit means to operatively connect to said cartridge, such that said mixtip forms a fluidly connected passage from said distal opening of said cartridge. The device as above may also include one or more pistons receivable within each cavity and juxtaposed to one of said piston elements. The diameter of one cavity may be different than the diameter of another cavity for the purpose of changing the ratio of the packaged product. The outer wall of one cavity, preferably the smaller of the two when they are of different sizes has outwardly extending ribs for the purpose of maintaining said fixed periphery of said cavity. The break-off section has a figure-eight cross section. In a preferred device the variability of the inner wall diameter and the length of the cavity combine to suitably permit a range of mixed product configurations from 0.25 mL to 3.0 mL. The variability of the inner wall diameter and the length of the cavity may combine to suitably permit a range of mixed product configurations from 0.10 mL to 5.0 mL. The mixtip preferably has a fixed inner wall that mates connectedly with said fixed outer wall periphery of said cavity and said fixed outer wall periphery of said distal opening. The mixtip may have a confluence point wherein said formed passage from said distal openings of said cartridge converge into a substantially single passageway which contains a static mixing element. Said mixtip preferably fits a plurality of cartridges with different inner wall configurations and may fit a plurality of cartridges with different length configurations. There may also be provided a piston with a forward facing flange and slits for the purpose of venting air from said cartridge. A frangible seal may cover said proximal openings. The fixed outer wall periphery of said distal opening may be a section of a tapered cone.

In general, a package for the storage and dispensing of a plurality of material 10as comprises a first and a second longitudinally juxtaposed barrels; each said barrel having a first and a second end; each said first and second barrels having a quantity of at least one of the material 10as initially contained therein; each said barrel having an open end and a dispensing end; a sealing piston disposed in each said barrel such that the material 10a in each said barrel is initially positioned between said dispensing end of said barrels and the respective ones of said sealing pistons; a snap cap contiguously formed to initially close each of said dispensing ends of said barrels; such that said snap cap may be broken from said barrels to thereby forming a secondary open end at said dispensing end of said barrels, thereby facilitating the material 10a contained in each said barrel to flow through and be dispensed.

A package for storing and dispensing a plurality of material 10as also comprises a first and a second longitudinally juxtaposed barrels; each said barrel having a first and a second end; each said first and second barrels having a quantity of at least one of the material 10as initially contained therein; each said barrel having a primary open end and a dispensing end; a sealing piston disposed in each said barrel such that the material 10a in each said barrel is initially positioned between said dispensing end of said barrels and the respective ones of said sealing pistons; a snap cap contiguously formed to initially close each of said dispensing ends of said barrels; such that said snap cap may be broken from said barrels to thereby forming a secondary open end at said dispensing end of said barrels, thereby facilitating the material 10a contained in each said barrel to flow through and be dispensed; and, a dispensing syringe having a first and a seconded axially displaceable syringe plunger, and an actuating means for axially displacing said syringe plungers; said first and second barrels having means to removably affix said barrels to said syringe; said first syringe piston being receivable within said primary open end of said first barrel, and being axially displaceable therethrough to contact said seal piston located in said first barrel; and, said second syringe piston being receivable within said primary open end of said second barrel, and being axially displaceable therethrough to contact said seal piston located in said second barrel.

A package for the storage and dispensing of a plurality of material 10as also comprises a first and a second longitudinally juxtaposed barrels; each said barrel having a first and a second end; each said first and second barrels having a quantity of at least one of the material 10as initially contained therein; each said barrel having an open end and a dispensing end; a sealing piston disposed in each said barrel such that the material 10a in each said barrel is initially positioned between said dispensing end of said barrels and the respective ones of said sealing pistons; a snap cap contiguously formed to initially close each of said dispensing ends of said barrels; such that said snap cap may be broken from said barrels to thereby forming a secondary open end at said dispensing end of said barrels, thereby facilitating the material 10a contained in each said barrel to flow through and be dispensed; and a mix-tip affixed to said first and second barrels and having a dispensing aperture, such that the material 10a that is dispensed from said secondary openings is caused to flow through said mixtip, and out through said dispensing aperture; a static mixing element contained within said mixtip to promote intimate contact and mixing of the material 10as.

A package for storing and dispensing a plurality of material 10as also comprises a first and a second longitudinally juxtaposed barrels; each said barrel having a first and a second end; each said first and second barrels having a quantity of at least one of the material 10as initially contained therein; each said barrel having a primary open end and a dispensing end; a sealing piston disposed in each said barrel such that the material 10a in each said barrel is initially positioned between said dispensing end of said barrels and the respective ones of said sealing pistons; a snap cap contiguously formed to initially close each of said dispensing ends of said barrels; such that said snap cap may be broken from said barrels to thereby forming a secondary open end at said dispensing end of said barrels, thereby facilitating the material 10a contained in each said barrel to flow through and be dispensed; and, a dispensing syringe having a first and a seconded axially displaceable syringe plungers, and an actuating means for axially displacing said syringe plungers; said first and second barrels having means to removably affix said barrels to said syringe; said first syringe plunger being receivable within said primary open end of said first barrel, and being axially displaceable therethrough to contact said seal piston located in said first barrel; and, said second syringe plunger being receivable within said primary open end of said second barrel, and being axially displaceable therethrough to contact said seal piston located in said second barrel; and a foil seal initially closing said primary open ends of said first and second barrels, such that when said syringe plungers are caused to be axially displaced into and received by said barrels, said foil seal is first caused to be punctured by physical contact with said syringe plungers.

The invention also provides a packaging and delivery system for fluid, gel or paste-like products that are made up of two separate and distinct compositions that must be mixed together prior to application. In particular, the invention is advantageous for the unit-dose application of dental material 10as. Current dental applications include, but are not limited to impression material 10as, bite registration material 10as, tissue management material 10as, endodontic material 10as, rubber dams, resin based core build-up material 10as, resin based temporary material 10a, resin based permanent and temporary cements, adhesives, calcium hydroxide pulp-capping material 10as and tooth bleaching products. It should also be recognized that there might be other product applications outside of the dental industry that would similarly benefit from this invention such as commercial epoxies, industrial adhesives or medical cements, just to name a few.

### BRIEF DESCRIPTION OF THE DRAWINGS

FIG. 1 is a sectional, perspective view of a package according to the invention.

FIG. 2 is a perspective view of a package according to the invention, showing component parts in an exploded manner.

FIG. 3 is a front elevational view of a package according to the present invention, showing part of an optional piston and an optional mix tip in place upon the package.

FIG. 4 is a perspective view of a package according to the invention, also showing an optional mix-tip.

FIG. 5 is a perspective view as in FIG. 4, showing the inventive device affixed to a dispensing device.

FIG. 6 is a front elevational, sectional view of a package according to the present invention.

FIG. 7 is a top, plan view of one end of the inventive package.

FIG. 8 is a side elevational view of an alternative embodiment of the invention.

FIG. 9 is a front elevation, sectional view taken along line 9-9 of FIG. 8.

FIG. 10 is a close up front view of one portion of the embodiment of FIG. 8.

FIG. 11 is a perspective view of the device of FIG. 8 shown with a snap-cap removed.

FIG. 12 shows a front elevational view of one embodiment of a sealing piston useful with the present invention.

FIG. 13 is a front, sectional view of the piston of FIG. 12 and taken along line 13-13 thereof.

FIG. 14 shows a perspective view of the sealing piston of FIG. 12.

FIG. 15 shows a perspective view of a mixing tip useful with the present invention.

FIG. 16 shows a front elevational view of the mixing tip of FIG. 15.

FIG. 17 shows a side elevational view of the mixing tip of FIG. 15.

FIG. 18 is a front, sectional view of a filled cartridge that has been assembled to a mix tip and is ready for use, each being exemplary of the present invention.

FIG. 19 is a close-up, detail view of one portion of FIG. 18.

FIG. 20 is a side elevational view of the device of FIG. 18.

FIG. 21 is a front sectional view of one portion of the device of FIG. 18.

FIG. 22 is an exploded view of a syringe and plunger assembly useful in the practice of the present invention.

FIG. 23 is an exploded view showing an alternative embodiment of a mixtip and a piston.

FIG. 24 shows a progressive series of devices as in FIG. 8 configured to hold and dispense different amounts of material 10a.

FIG. 25 is a section view of a device according to the present invention as in FIG. 8, showing alternative volume capacities by phantom lines.

FIG. 26 is a section view of one portion of the device shown in FIG. 25, showing alternative dimensions by phantom lines.

FIG. 27 is a front elevational and sectional view of an alternative embodiment of the invention shown in FIG. 1.

FIG. 28 is a perspective non-sectional view of the device of FIG. 27.

FIG. 29 is a close-up, detail view of one portion of the device of FIG. 1.

FIG. 30 shows a section view of an alternative embodiment of one portion of the device of FIG. 29, taken along line 30-30 thereof.

FIG. 31 shows a section view of an alternative embodiment of one portion of the device of FIG. 29, taken along line 31-31 thereof.

FIG. 32 shows a section view of an alternative embodiment of one portion of the device of FIG. 29, taken along line 32-32 thereof.

### PREFERRED EMBODIMENTS FOR CARRYING OUT THE INVENTION

A multiple component, unit-dose container delivery system according to the invention is shown by way of example on the drawings by the number 10. Package 10 can be used for the storing and dispensing of any type or quantity of material 10a such as material 10a, but is particularly suited for storing and dispensing of dual-component dental adhesives or the like.

Package 10 includes a plurality of barrels, such as barrels 11 and 12. Package 10 is exemplified with two barrels 11 and 12, it being understood that any numbers of such barrels is within the scope of the invention. Barrels 11 and 12 are preferably elongated having open areas or cavities 13 and 14 respectively therein.

Barrels 11 and 12 are preferably juxtaposed in their longitudinal direction, although other configurations are within the scope of the invention. That is, each barrel 11 or 12 preferably has a center axis that is parallel to the axis of the other barrel 11 or 12. Further, each barrel 11 and 12 is provided with a first, primary or proximal opening end 20 and a secondary or distal opening 21, each of the proximal openings 20 allowing access to cavities 13 and 14 respectively. Proximal opening 20 may be thought of as being the “inlet end” of the package 10 and distal opening 21 may be thought of as being the “discharge end” of the package 10, for reasons that will become clear from the following discussion. It is also to be understood that it is preferred that each barrel 11 and 12 have its own proximal opening 20 and a distal opening 21.

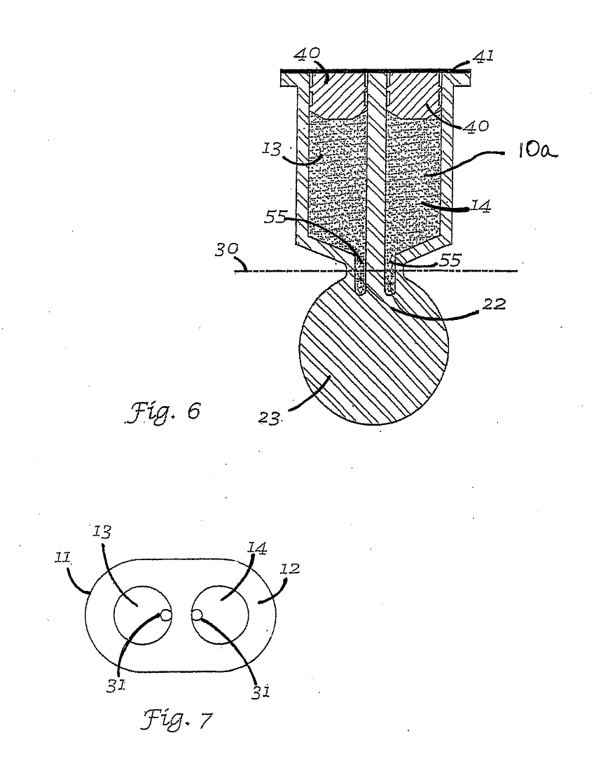

Each of the respective distal openings 21 of barrels 11 and 12 is provided with a dispensing aperture 22 that is initially closed by snap-cap or break-cap 23. Preferably, snap-cap 23 is integrally formed with barrels 11 and 12. Further, snap-cap 23 can be broken from barrels 11 and 12 by snapping or breaking it therefrom, such as at break point 30 (FIG. 6) or some other location. Preferably when snap-cap 23 is broken from barrels 11 and 12, secondary openings 31 are formed in each of said barrels 11 and 12, such that cavities 13 and 14 can fluidly communicate therethrough, allowing for the dispensing of the material 10as through secondary openings 31. Preferably, barrels 11, 12 and snap cap 23 are formed from a suitable plastic material 10a that will allow the breaking operation. More preferably, such components are formed as a single unit in for example, an injection molding operation or the like.

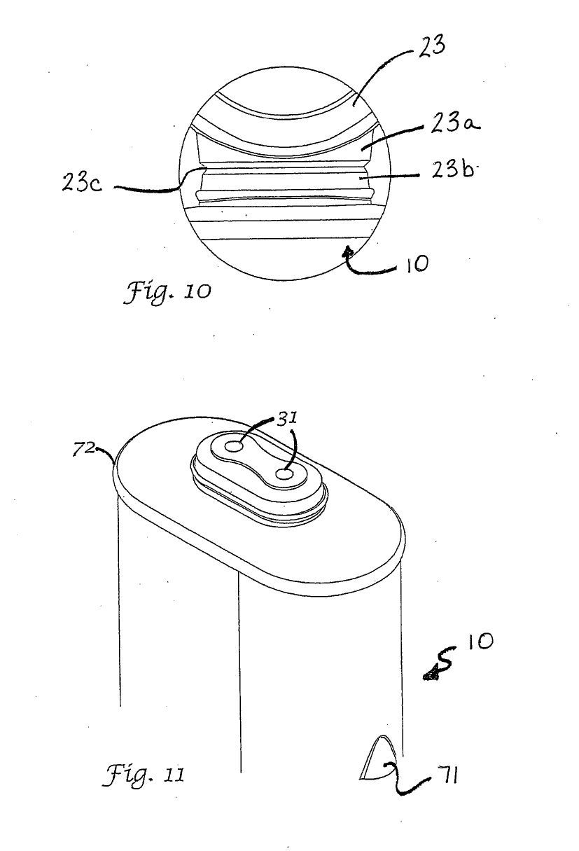

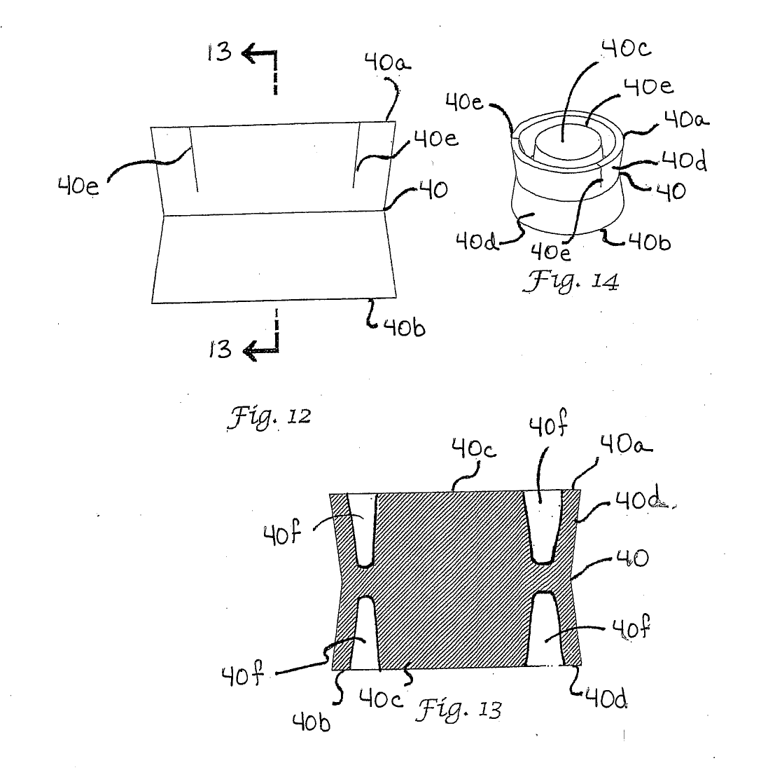

In the embodiment of the snap-cap 23 shown in FIG. 10, snap-cap 23 is connected to a base 23a while package 10 is provided with a neck 23b such that base 23a and neck 23b are integrally connected and/or formed in a juxtaposed manner, and more preferably is a contiguous and opposed relation. Thus, as manufactured, snap-cap 23 and package 10 are physically connected. It will be appreciated that in the connected configuration, secondary openings 31 are closed over by the connecting surfaces. When a user (not shown) grasps package 10 and exerts a sufficient force upon snap-cap 23, the connection between base 23a and neck 23b is broken or fractured, thereby uncovering or exposing secondary openings 31 to the atmosphere. In the configuration where the snap-cap 23 has been removed (see FIG. 11), it is preferred that the remaining material 10a still connected to package 10 forms a figure-8 pattern.

As also shown in FIG. 10, in order to facilitate and guide the fracture of the connection between base 23a and neck 23b, a groove 23c may be formed therein by any conventional means such as molding, milling, cutting or any such forming method. In this manner, the subsequent fracturing of the connection between base 23a and neck 23b is caused to follow the groove because there is less material in the cross section at the groove and hence that portion of the groove 23c is weaker than the remaining portion of the connection. One useful configuration of the groove 23c is a V-groove as depicted in the drawings. As the V-groove propogates around the neck, it is deeper on the sides than on the ends, thereby defining a figure-8 cross section at 23c. The figure-8 V-groove 23c acts to concentrate the stress across the connected portion between base 23a and neck 23b in such away that the connection or ligament fractures along the intended breaking plane.

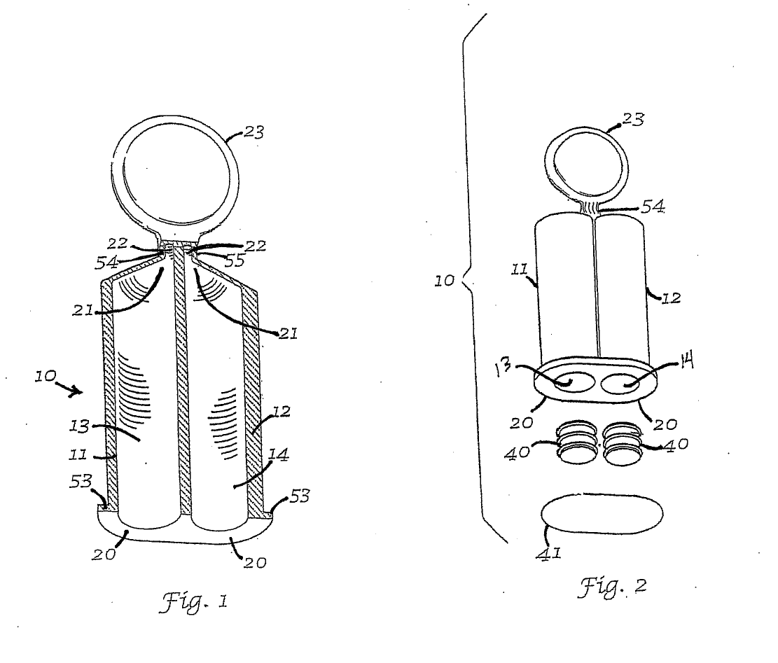

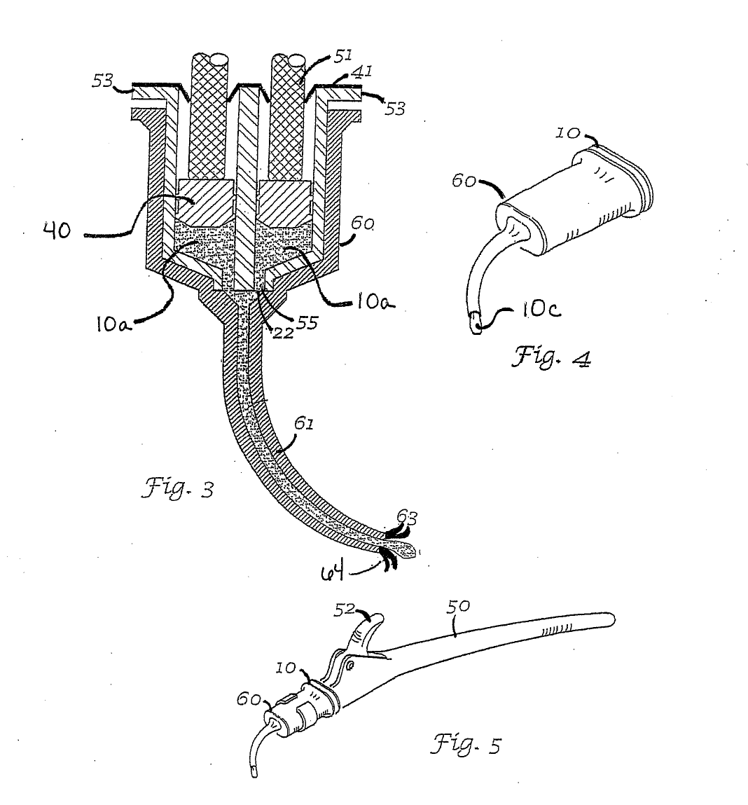

As shown in FIG. 2, there is also preferably provided, a plurality of sealing pistons 40, preferably at least equal to the number of barrels 11 and 12 employed. The material 10a to be dispensed is initially placed into cavities 13 and 14 by input through proximal openings 20 in each said barrel 13, 14. Pistons 40 are receivable within cavities 13 and 14, through proximal openings 20, such that the material 10a is between said pistons 40 and said snap-cap 23 (FIG. 6), effecting the storage function of the package 10. In this configuration, the materials 10a within barrels 11 and 12 are prevented from being exposed to the environment. When it is desired to dispense the material 10a, snap-cap 23 is broken from package 10 thereby creating or exposing secondary opening 31 that fluidly communicate between cavities 13 and 14 and the environment, as was above discussed. Pistons 40 are preferably formed from an elastomeric plastic, rubber, rubber-like, or other polymeric material and dimensioned to fit snugly within cavities 13, 14 to effectively seal the cavities 13 and 14 from the environment, having been inserted through proximal openings 20. In one embodiment of a piston 40 shown in FIG. 2, piston 40 is provided with at least one and preferably a plurality of sealing rings 40′.

An alternative embodiment of a piston 40 is shown in FIGS. 12-14. In this embodiment, piston 40 is configured to have a leading edge 40a and a trailing edge 40b. Each of said leading edge 40a and trailing edge 40b is provided with an base 40c and an outer surrounding skirt 40d. At least one of the edges 40a or 40b has a skirt 40d that has at least one and preferably a plurality of slits 40e therein. Preferably at least leading edge 40a has a skirt 40d having slits 40e therein, such that as leading edge 40a is inserted into a cavity 13 or 14, air may escape through slits 40e. In this configuration, trailing edge 40b still provides an effective seal. Between contiguously formed skirts 40d and base 40c there is preferably a void 40f. Further, it is also preferred in this embodiment to angle the skirt 40 associated with leading edge 40a with respect to skirt 40d associated with trailing edge 40b. In this manner, a secure and snug fit within a given cavity 13, 14 is assured. Skirt 40d is preferably somewhat flexible and can be made slightly larger than cavity 13, 14, but can then be contracted enough by deforming into void 40f to fit within the given cavity 13, 14.

After pistons 40 are received through proximal openings 20 and into cavities 13 and 14, openings 20 may be further sealed with any type of layer, such as film or foil layer 41. Any layer 41 is within the scope of the invention and layer 41 may be removable, frangible, piercable, cuttable or the like.

To further facilitate the dispensing of the material 10a through secondary openings 31, a dispensing syringe 50 of any design may be employed. One preferred dispensing syringe has at least one syringe plunger 51, and preferably the same number of syringe plungers as barrels 11, 12 are present in package 10, although this is not necessary. Further still, syringe 50 should have some means such as hand-lever 52 to axially displace syringe plungers toward proximal openings 20 when package 10 is mounted upon syringe 50. Further, package 10 should be provided with some means to removably secure package 10 to syringe 50, such as lips or shoulders 53 that interact such as by a friction or snap fit to syringe 10, to thereby removably secure package 10 thereto. An example of such a syringe is found in for example, commonly assigned U.S. Pat. No. 4,708,650, which is hereby incorporated by reference for such disclosure. When syringe plungers 51 are axially moved toward barrels 11, 12, the foil layer 41 may be physically impinged by and then punctured by syringe plungers 51, or the foil layer 41 may be removed before such action. Further, as syringe plungers 51 are axially displaced toward barrels 11, 12, they will be received through proximal openings 20 and into cavities 13 and 14, to thereby physically contact pistons 40. Continued axial displacement of syringe plungers 51 toward end 21 of barrels 11, 12 will cause the material 10a between ends 21 and pistons 40 to be forced or moved toward second ends 21, to be dispensed through secondary openings 31.

A neck area 54 may be provided between snap-cap 23 and second ends 21 of barrels 11, 12, preferably such that passages 55 extend from cavities 13 and 14 and at least partially into neck area 54. By being of a reduced size as compared to snap-cap 23 and/or barrels 11,12, the break area 30 is facilitated by neck area 54. Break area 30 is preferably located such that passages 55 extend on either side thereof, such that when snap-cap 23 is broken from barrels 11, 12, secondary openings 31 are thereby formed to fluidly communicate with the exterior of package 10. This configuration was above discussed.

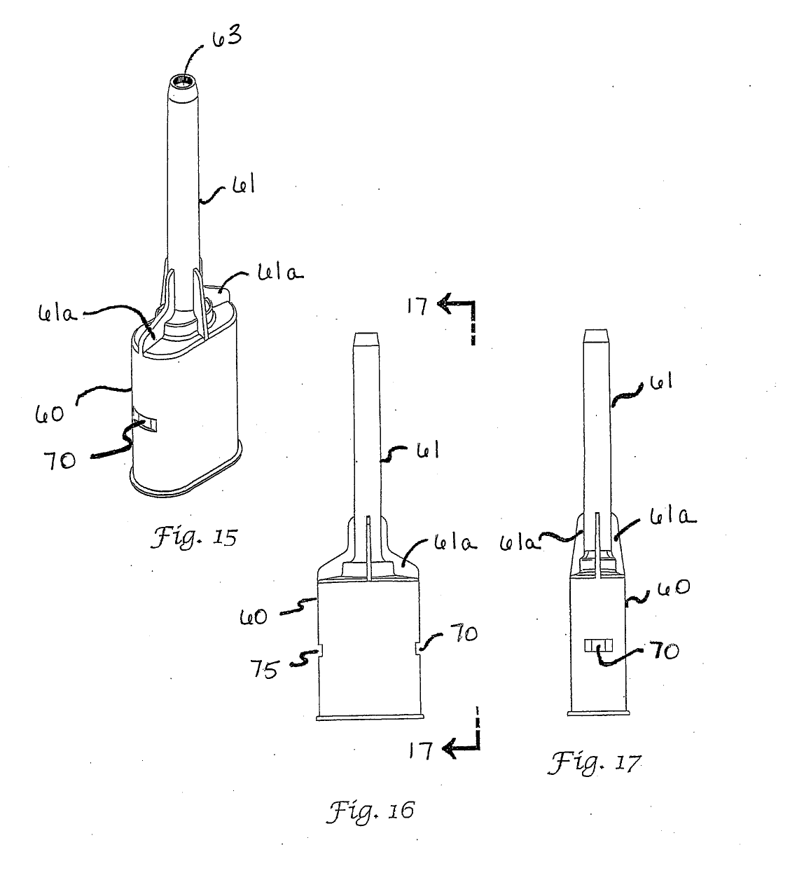

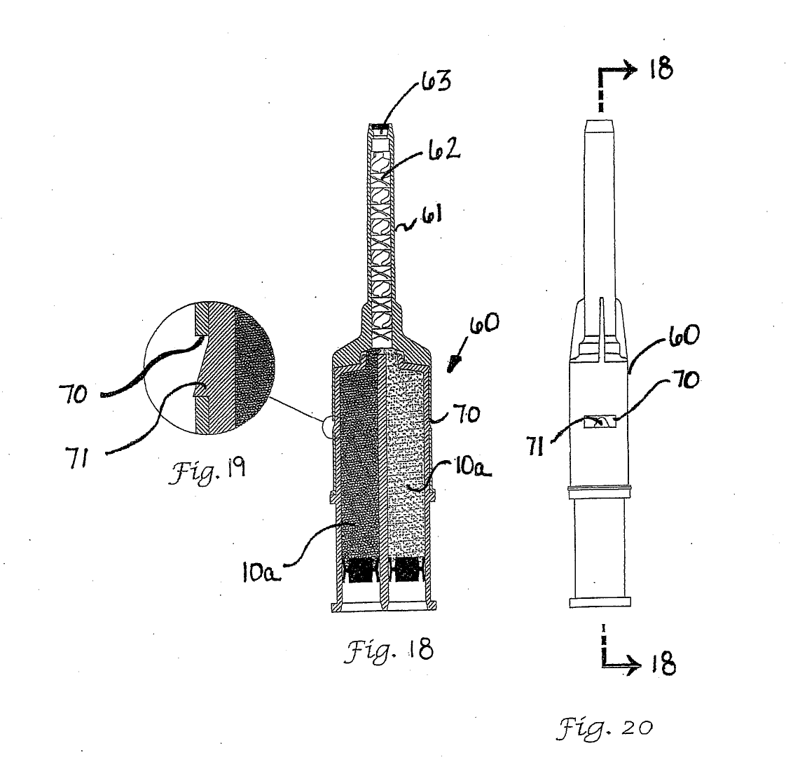

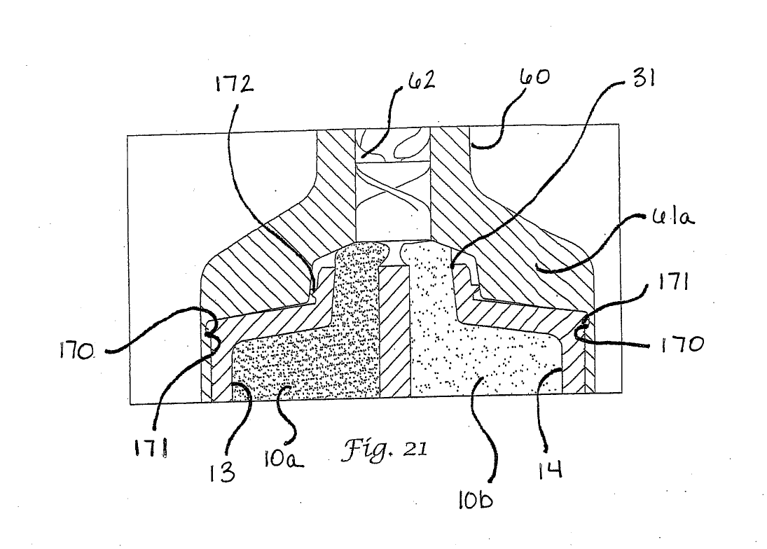

Package 10 may also be provided with a mix-tip 60 (FIGS. 4 and 15-21), such that the material 10a dispensed through secondary openings 31 is first mixed within a mix-tip dispensing tube 61. Tube 61 may even be provided with a static mix element 62. One such mixing element is exemplified in the U.S. Pat. No. 4,850,705 which is hereby incorporated by reference for such disclosure. The material 10a from barrels 11 and 12 are combined and mixed within tube 61 (see FIGS. 18 and 21), preferably the mixing being enhanced by mix element 62. Tube 61 is provided with dispensing opening 63, fluidly communicating between the interior of tube 61 and the environment. If desired, brush bristles 64 may be located adjacent, within or surrounding dispensing opening 63 of mix tip 60, to facilitate application of the dispensed material 10a. Tube 61 may be provided with strengthening ribs 61a.

Mix-tip 60 is preferably affixable to package 10. Any conventional means of affixing mix-tip 60 to package 10 is within the scope of the invention, such as friction, or more preferably by a snap fit. For example, holes or apertures 70 may be provided in the mix-tip 60 to match and receive triangular-shaped nubs 71, thereby holding mix-tip 60 to package 10. Holes 70 may be formed from a plastic or other deformable material to facilitate placement of mix-tip 60 upon package 10. Of course, package 10 may carry detents and mix-tip 60 could carry nubs (not shown), and still fall within the scope of the invention. Whatever means or structures are chosen, including holes 70 and nubs 71, it is preferred to integrally form such complementary components with their respective package 10 or mixtip 60.

The size dimensions of package 10 may vary depending upon the nature of the materials 10a to be dispensed, but package 10 in a preferred embodiment is of a unit-dose size for such materials 10a, as such term is commonly employed in certain industries including the dental industry. Double, triple or multiple unit-dose sizes are also within the scope of the invention. It is also possible to employ the invention in a non-unit-dose or bulk container size.

Preferably, the package 10 is made from a brittle plastic (as opposed to a ductile plastic) that will for example, fracture when a suitable force is applied to snap-cap 23. Cyclic olefin copolymer (COC) and polypropylene (PP) homopolymer have both been used successfully as cartridge or package 10 materials. The package 10 can be made from opaque plastic (for products that require light protection) or they can be made from translucent plastic in order to allow the user to visualize how much is left in the package 10. In use, the package 10 should provide appropriate barrier properties for the products contained within the barrels 11,12 if such is required. It should therefore be recognized that different products might require package 10 to be formed from different materials and there may be many suitable materials of construction for the package 10 depending upon the desired end use and nature of the material 10a contained within the package 10.

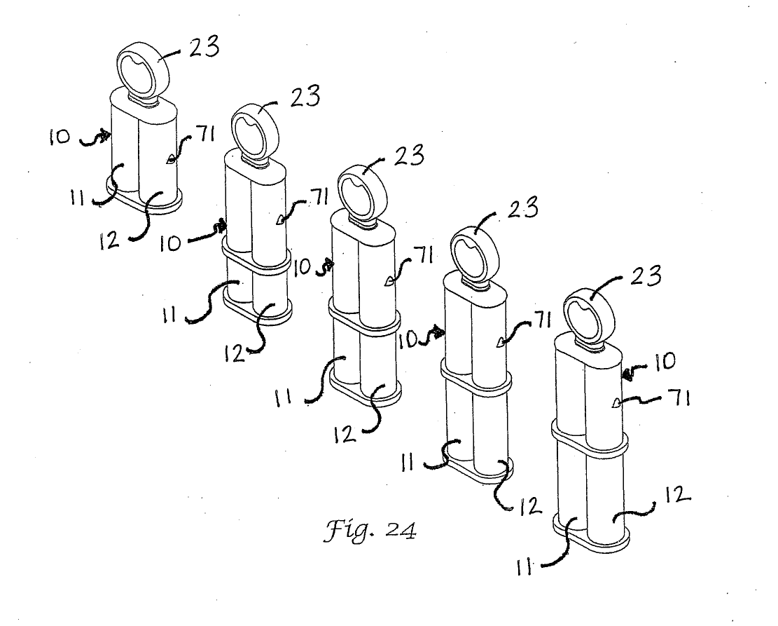

FIG. 24 illustrates a family of cartridges with different volume capacities from each other. This configuration provides a cartridge delivery system that can be tailored to specific product requirements depending on the amount of material 10a needed. In addition, a kit of different sizes may be fabricated. This configuration is particularly useful for a wide range of unit-dose applications under about 2.5 mL.

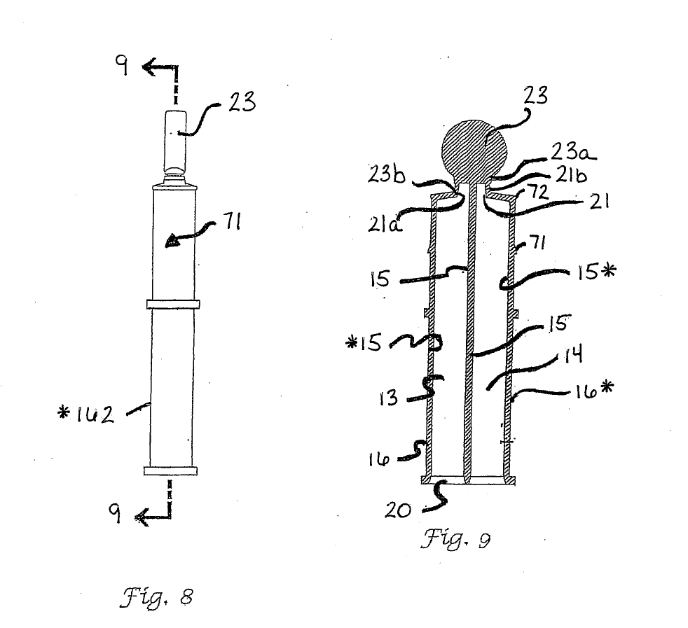

With reference to the drawings and particularly FIGS. 8 and 9, package 10 has cavities 13 and 14 as above discussed. As was also discussed, each cavity 13 and 14 is preferably elongated having a longitudinal axis that is arranged parallel to the longitudinal axis of the axis of at least one other cavity 13 or 14. Cavities 13 and 14 are preferably formed by an inner wall 15 and outer wall 16, and each cavity is preferably physically adjacent to one another. Inner wall 15 may be a shared structure between cavities 13 and 14 and outer walls 16 may be contiguously formed.

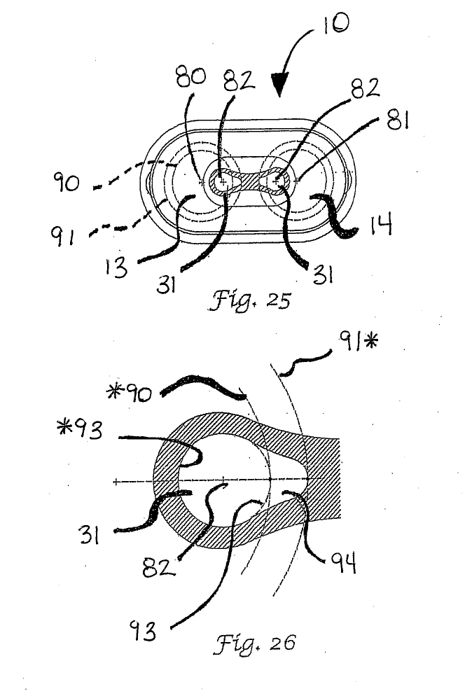

Preferably, each axis of each cavity 13 and 14 is separated by a fixed dimension and the outer wall 16 is of a fixed or predetermined periphery. The inner wall 15 of cavities 13 and 14 is preferably of variable cross section for the purpose of varying the volume of cavities 13 and 14. That is, the actual dimension thereof may be preselected during manufacture of package 10 and then changed if desired for the fabrication of another package 10. For example, as shown in FIG. 25, package 10 is provided with cavities 13 and 14 as above discussed. Each cavity 13 and 14 has a longitudinal axis, the position of which is represented by center marks 80 and 81 respectively in FIG. 25. Similarly, secondary openings 31 may also be provided with a central axis the position of which is represented by center mark 82. The relative positioning or dimension between the axis 80 and 81, is preselected and fixed, as is the position of central axis 82 of secondary openings 31, with respect to themselves and each other. Distal openings 21 are thus on a fixed center to center dimension and located on a plane between cavity axes 80, 81 and located within the inner wall 15 boundary of each of the cavities 13 and 14.

The volume of a cavity 13 or 14 is dependent upon the dimensions thereof. That is, the volume may be changed by changing the length and/or the diameter of a given cavity 13 or 14. It is desired however, that even as these dimensions are changed, that the preselected position of axis 80 and 81 as well as central axis 82 of secondary opening 31 remain fixed. For example, the inner diameter of cavity 13 in FIG. 25 represented by phantom line 90 would result in a cavity 13 having a certain preselected volume. By making the inner diameter larger, as represented by phantom line 91 in FIG. 25, the volume of cavity 13 can be made larger. It will be appreciated that as between the different volumes represented by the inner diameters of phantom lines 90 and 91, the relative position of axis 80 does not change with respect to axis 81 of cavity 14, nor does it change with respect to central axis 82 of secondary opening 31. It is also desired, that inso doing, the periphery of outer wall 16 remains fixed. In this manner, multiple mixtips 60 of singular dimensions can be employed no matter what the volume or inner diameter or volume size of cavities 13 or 14 may be, because the positions of axes 80 and 81 and the periphery of outer wall 16 do not change between packages 10 having different volumes.

In a similar manner, the volume of material 10a able to be dispensed through secondary openings 31 can be changed by changing the dimensions or shape of an opening 31. As shown in FIG. 26, a secondary opening 31 having the shape represented by phantom line 93 will result in a certain amount of material 10a being able to be discharged therethrough. As such, the largest secondary opening 31 permitted is a circle represented by phantom line 93 and solid line 93′ which is tangent to the inner wall 15 represented by phantom line 90. When the diameter of cavity 13 and 14 is increased as represented by phantom line 91, secondary opening 31 may be increased by the addition of lobe 94, thereby increasing the cross section, although the disharge capacity is different between them it will be appreciated that the location of central axis 82 will remain the same. Thus, multiple mixtips 60 of singular dimensions can be employed no matter what the volume capacity, size or shape of secondary openings 31 may be, because the positions of each central axis 82 does not change as between packages 10 having secondary opening 31 of different dimensions. It will also be appreciated that a secondary opening 31 may have a size dimension different than that of a secondary opening 31 of the same package 10.

Put another way, distal openings 21 preferably also have an inner and outer wall 21a and 21b respectively (FIG. 9). Preferably, outer wall 21b of said distal opening 21 is of a fixed or predetermined periphery. The inner wall 21a of a distal opening 21 is of a variable cross section as selected by the manufacturer, for the purpose of varying the flow of material 10a through the distal openings 21.

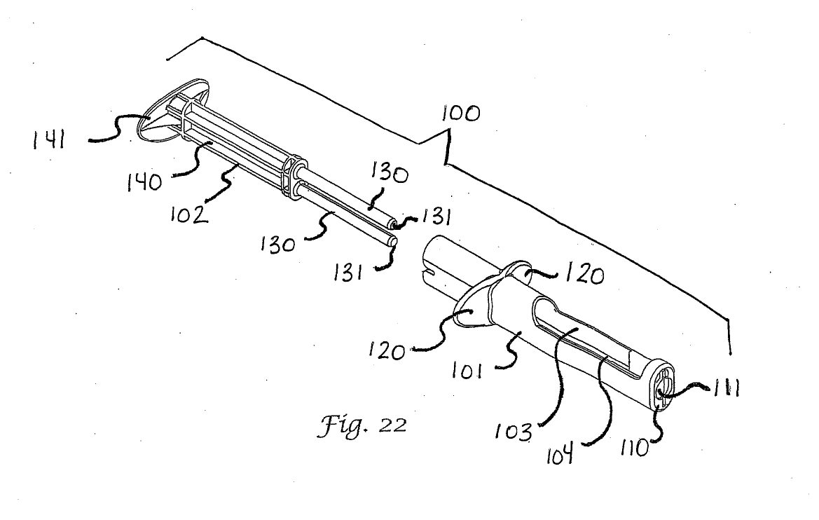

As stated above, a mixtip 60 may be affixed to package 10 as can a dispenser such as syringe 50. An alternative embodiment of a dispenser is generally designated by the number 100 in FIG. 22. Dispenser 100 has a holding assembly 101 and a plunger assembly 102. Holder assembly 101 is configured to receive a package 10 within securing cavity 103 through window 104. It will be appreciated that by dimensioning holding assembly 101 to be complementary to a package 10, package 10 can be held within securing cavity 103 in a snug or friction fitting manner. Of course, any other method of holding a package 10 therein is within the scope of the invention. In addition, it is preferred to configure holding assembly 101 to receive and accommodate not only a package 10 but also a package 10 with an affixed mixtip such as mixtip 60. For example, holding assembly 101 may be provided with a front wall 110 having an aperture 111 therein such that aperture 111 may accommodate a tube 62. Finger tip wings 120 may also be provided with or integrally formed with holding assembly 101. Wings 120 provide a user with means of exerting force upon holding assembly 101 in a direction opposite that of that normally applied to plunger assembly 102 when dispensing material 10a from a package 10 and in a manner to now be described. By “finger tip” it is simply envisioned that a user will place a finger on each wing 120 and one on each side of holder assembly 101 during use, although such a manipulation is not necessarily a limitation of the invention.

Plunger assembly 102 is provided with a plurality of plunger elements 130, each dimensioned to be received within a proximal opening 20 of a package 10. Although depicted in the drawings as being of similar or even identical dimensions, it will be appreciated that the dimension as between different plunger elements 130 of a given plunger assembly 102 may vary depending upon the size dimension of the cavity such as cavity 13 or 14 within which plunger element 130 is received through proximal opening 20. Again however, this is not necessarily a limitation of the invention. The length dimension of each plunger element 130 may also vary as desired.

Each plunger element 130 is preferably provided with a facing 131 configured to physically contact or impinge upon a piston 40, if a piston 40 is used in a given cavity 13, 14. The preferred embodiment is to have a separate piston 40 placed within a cavity 13, 14, which is then physically contacted by a facing 131 of a finger 130.

Plunger assembly 102 is also provided in the preferred embodiment with an elongated spacing section 140 which terminates at its end distal to plunger elements 130 in a thumb press or pad 141. At end of spacer element 140 proximal to plunger elements 130, plunger elements 130 are affixed to the spacer element. Preferably all of the components making up the plunger assembly 102 are integrally formed, but they may be affixed together in any suitable manner.

In use, the user will place a package 10 with an affixed mixtip 60 into holding assembly 101 as above discussed. The user then places each plunger 130 of plunger assembly 102 into a cavity 13, 14 through a respective proximal opening 20. By placing fingertips (not shown) on the wings 120 and pulling toward plunger assembly 102 while simultaneously pushing upon thumb pad 141 with a thumb (not shown) the plunger elements 130 can be caused to move within cavities 13,14 in a direction toward secondary opening 131. Continued such displacement of plunger elements 130 within cavities 13, 14 will eventually cause piston elements 40 to be displaced in a similar direction, and eventually will cause material 10a within package 10 to be dispensed through secondary opening 31 in the manner above described. It will be appreciated that user manipulation of holder 100 results in an operation at least somewhat similar to that of a conventional syringe. As such, the dimensions of the component parts including spacer 140 and the like can be varied depending upon the needs of the user.

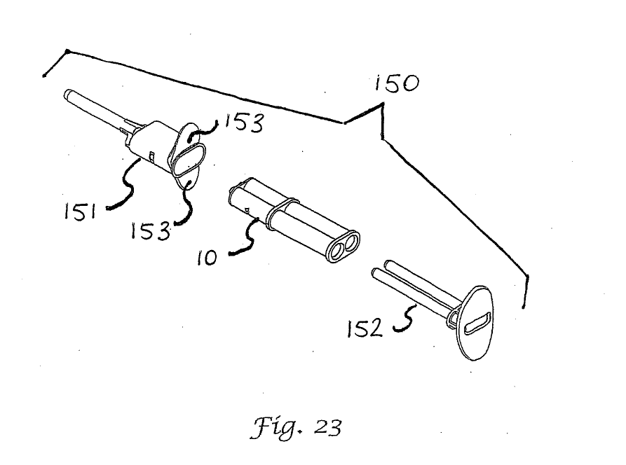

An alternative holder assembly is designated by the number 150 in FIG. 23 which includes a package 10 in this exploded view for illustrative purposes. Holder 150 includes a winged mixtip 151 and a plunger assembly 152. Winged mixtip 150 is substantially identical in form and function to mixtip 60 described above, except that it is provided with mixtip wings 153 that operate in a manner similar to wings 120 above described. Alternative plunger assembly 152 is substantially similar in design and function to plunger assembly 102 above described. By including mixtip wings 153 upon a winged mixtip 151, a user may dispense a package 10 in a manner similar to that described above with respect to holder 100. It will be further appreciated that plunger elements 130 have an axial dimension that is coincident with axis of the cavity 13, 14 within which it is received. It may also be the case that a piston 40 may be affixed to a plunger 130 of plunger assembly 152 such as being adhesively bonded, friction fitted, integrally formed with or otherwise affixed to plunger 130.

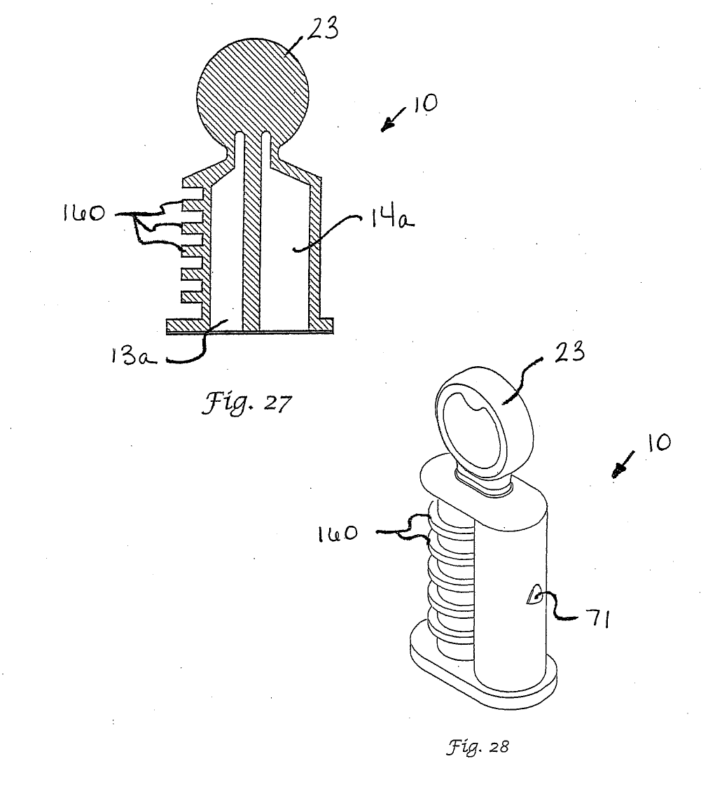

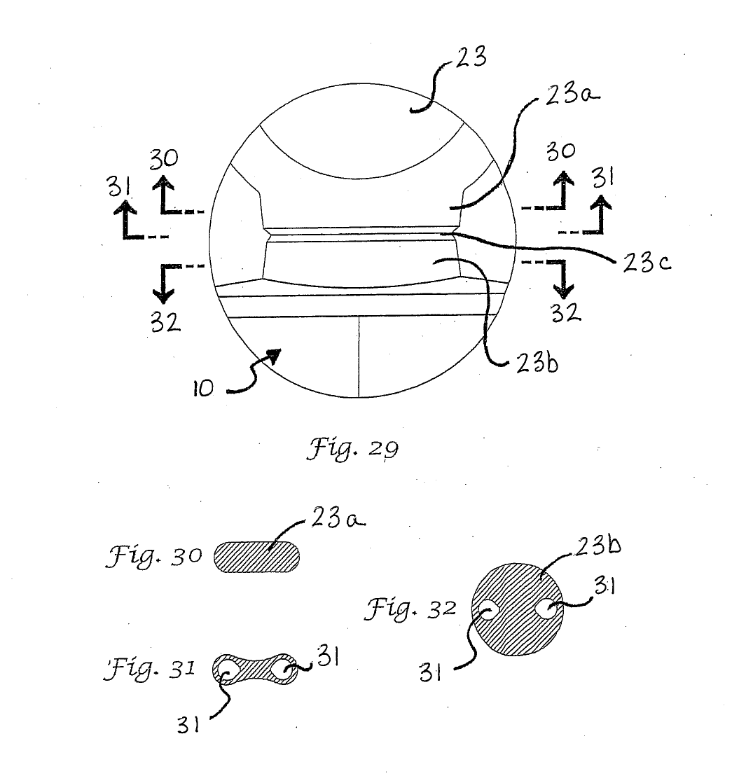

In one embodiment of the invention, cavities 13, 14 are of equal dimension such that the material 10a is dispensed therefrom in a 1:1 ratio. In another embodiment of the invention, the cavities 13 and 14 can be different sizes from each other in order to accommodate products with mix ratios other than 1:1. For example, a product with a 3:1 mix ratio could be delivered by having one smaller cavity 13a and one large cavity 14a (FIGS. 27 and 28). When molding plastic components it is desirable to have uniform wall thickness, so ribs 160 could be utilized to keep the wall thickness consistent. In order to universally fit a mixtip 60 or 151 the ribs 160 would take up the same space as the outer periphery as would a package 10 without ribs 160.

Returning to the user-induced fracture between snap-cap 23 and package 10, a finite element analysis study (FEA) determined that the optimal cross section for the breaking ligament between base 23a and neck 23b is the figure-8 shape as shown in FIG. 11. The FEA determined that this shape in conjunction with the V-groove 23c produces stress concentration, which results in a uniform fracture along the intended plane. This holds true for both bending and torsional fracture modes.

The cross section of the inventive cartridge neck 23b is oval but it could even be circular or some other shape if desired. A circular neck as shown in FIG. 29 and FIG. 32 would require a similarly shaped circular pocket in the mixtip and would have the added benefit of having a more uniform distribution of forces than the oval configuration. Conceivably, this would result in better sealing characteristics and less backflow.

As stated above, any means may be provided to affix mixtip 60 to a package 10. Another exemplary means includes for example, a detent 170 (FIG. 21) may be provided within mixtip 60 such that as a package 10 is received therein a rim 171 carried by package 10 is received therein, preferably in a snap-fit manner. Similarly, neck 23b of package 10 may be provided with a ring or spacer 172 that physically contacts mixtip 60 as a means to provide a seal between mixtip 60 and package 10.

Various alterations and modifications of the invention will be apparent to those of ordinary skill in the art without departing from the scope and spirit of this invention. Accordingly, it should be understood that the invention is not limited to the illustrative embodiments set forth herein.

What is claimed is:

1. A method for making a package and dispensing system for a material 10a having multiple precursor components, comprising the steps of:
providing a cartridge having a plurality of cavities, the axis of each cavity parallel to one another,
wherein said cavities are comprised of an inner and outer wall and each said cavity is adjacent to one another,
wherein said axis of each cavity is separated by a fixed dimension and said outer wall is of a fixed periphery,
wherein said inner wall of said cavities are of variable cross section for the purpose of varying the volume of said cavities,
said cavities having a proximal opening and a distal opening through which the material can be discharged,
wherein said distal openings are on a fixed center to center dimension and located on a plane between said cavity axis and located within the inner wall boundary of each of the said cavities,
wherein said distal openings have an inner and outer wall,
wherein said outer wall of said distal opening is of a fixed periphery
wherein said inner wall of said distal opening is of a variable cross section for the purpose of varying the flow of the material through said distal openings;
further providing a mixtip that affixes to said fixed periphery of said cartridge cavity outer wall and fixed periphery of said distal opening outer wall, and a dispenser that is comprised of a holding mechanism for said cartridge and mixtip; and a plunger assembly having a plurality of plunger element, wherein the axis of said plunger elements are coincident to the axis of said cartridge cavities and are displaceable in order to exert an axial force to discharge the material.

2. A method as in claim 1, wherein the cavity of said cartridge is lengthened along its axis to increase the volume of said cavity.

3. A method as in claim 1, wherein the distal openings have lobes that extend inwardly along a plane between the axis of said openings and said lobes are for the purposes of increasing the cross sectional area of said distal openings.

4. A method as in claim 1, wherein said cartridge has a break-off top for opening said distal openings.

5. A method as in claim 1, wherein said mixtip has as snap-fit means to operatively connect to said cartridge, such that said mixtip forms a fluidly connected passage from said distal opening of said cartridge.

6. A method as in claim 1, further comprising at least one piston receivable within said cavity and juxtaposed to one of said piston elements.

7. A method as in claim 1, wherein the diameter of one cavity is different than the diameter the other cavity for the purpose of changing the ratio of the dispensed product.

8. A method as in claim 7, wherein the outer wall of the smaller cavity has outwardly extending ribs for the purpose of maintaining said fixed periphery of said cavity.

9. A method for forming distal openings in a cartridge, wherein said break-off section has a figure-eight cross section.

10. A method as in claim 2, wherein the variability of the inner wall diameter and the length of the cavity combine to suitably permit a range of product configurations from 0.25 mL to 3.0 mL.

11. A method as in claim 2, wherein the variability of the inner wall diameter and the length of the cavity combine to suitably permit a range of product configurations from 0.10 mL to 5.0 mL.

12. A method as in claim 1, wherein said mixtip has a fixed inner wall that mates connectedly with said fixed outer wall periphery of said cavity and said outer wall periphery of said distal opening.

13. A method as in claim 12, wherein said mixtip has a confluence point wherein said formed passage from said distal openings of said cartridge converge into a substantially single passageway which contains a static mixing element.

14. A method as in claim 12, wherein said mixtip fits a plurality of cartridges with variable inner wall configurations

15. A method as in claim 2, wherein said mixtip fits a plurality of cartridges with variable length configurations.
